(19) United States
(12) Patent Application Publication
(10) Pub. No.: US 2026/0238507 A1
(43) Pub. Date: Aug. 13, 2026

(54) CHAT TERMINAL, CHAT SYSTEM, AND METHOD FOR CONTROLLING CHAT SYSTEM

(71) Applicant: MAXELL, LTD., Kyoto (JP)

(72) Inventors: Naohisa TAKAMIZAWA, Kyoto (JP); Osamu KAWAMAE, Kyoto (JP); Yasunobu HASHIMOTO, Kyoto (JP); Masuo OKU, Kyoto (JP)

(21) Appl. No.: 18/879,317

(22) PCT Filed: Jun. 28, 2022
(86) PCT No.: PCT/JP2022/025645

§ 371 Date: Dec. 27, 2024

(51) Int. Cl. H04L 12/18; G10L 21/0208; G10L 21/0216

(52) U.S. Cl. CPC H04L 12/1813; G10L 21/0208; G10L 21/0216; H04L 65/403; G10L 2021/02087

(57) ABSTRACT

A chat system is configured with a chat terminal and a chat server which are connected so as to communicate from each other. The chat terminal collects, using a microphone connected to the chat terminal, a user voice uttered by a terminal user and a non-user voice uttered by a non-user who is present near the terminal user, transmits the user voice to the chat server, and receives a distribution audio from the chat server. The chat system obtains a correlation between the distribution audio and the non-user voice, reduces the non-user voice included in the distribution audio, and outputs the distribution audio from which the non-user voice has been reduced to an audio output unit connected to the chat terminal.

### TECHNICAL FIELD

The present invention relates to a chat terminal, a chat system, and a method for controlling the chat system.

### BACKGROUND ART

For business purposes and the like, a chat system implemented in a web conferencing system is used to have a remote conference for transmitting and receiving audio data between remote locations. In a chat of a conventional style, it was common that one chat terminal was provided in each location and a plurality of participants at the same location shared images and audio. However, in recent years, a chat application to be executed on a personal computer or a smartphone has been made available, which allows participants of a chat who are present at the same location to use their own terminal, respectively, to execute the chat applications.

The audio processing for inter-location conferences is mentioned in Patent Literature 1 (JP-A-H08-237627). Patent Literature 1 discloses a multi-point video conferencing system for the purpose of “preventing the voice of a speaker from being heard at a terminal of the speaker” (excerpted from Abstract). According to the multi-point video conferencing system of Patent Literature 1, the uttered voice is not delivered to the terminal of the speaker and thus is not output therefrom.

### CITATION LIST

### Patent Literature

Patent Literature 1: JP-A-H08-237627

### SUMMARY OF INVENTION

### Technical Problem

On the other hand, in the case where participants who are present at the same location use their own chat terminals, respectively, to attend a conference, the voice uttered by one of the participants (referred to as a participant A) for a remote conference (referred to as an inter-location conference) is collected by a microphone provided in the chat terminal of the participant A, transmitted to a chat server, distributed to a chat terminal of a participant at a different location and a chat terminal of a different participant (for example, a participant B) at the same location, and output from speakers or earphones of the chat terminals. This causes the participant B to hear the voice of the participant A (non-user voice) both directly and through the distribution audio output from the chat terminal of the participant B. Herein, the “non-user voice” refers to the voice uttered by a different person (person who is not the user of the chat terminal) at that location and thus the voice that can be heard directly. The “distribution audio” refers to the audio to be output from a chat terminal.

The distribution audio routes through the chat server, and thus includes delay in its distribution. When the non-user voice and the distribution audio overlap each other, the same audio is reproduced twice with a time difference, which makes it very difficult to hear them.

According to Patent Literature 1, the speaker's own voice can be prevented from being heard by the speaker at his or her terminal, however, the problem of the audio interference between the non-user voice and the distribution audio which occurs in the case with a plurality of chat terminals at the same location is not considered, and thus has remained unsolved.

The present invention has been made in view of the circumstances described above, and an object of the present invention is to eliminate the inconvenience that, in the case where a plurality of participants at the same location uses their own chat terminals, respectively, to attend a conference, a non-user voice uttered from the participant who is present near the user interferes with distribution audio, which makes it difficult for the user to hear the non-user voice.

### Solution to Problem

In order to solve the problems described above, the present invention includes the features according to the scope of claims.

### Advantageous Effects of Invention

According to the present invention, it is possible to eliminate the inconvenience that, in the case where a plurality of participants at the same location uses their own terminals, respectively, to attend a conference, a non-user voice uttered from a participant who is present near a user interferes with distribution audio, which makes it difficult for the user to hear the non-user voice. The problems, configurations, and advantageous effects other than those described above will be clarified by explanation of the embodiments below.

### BRIEF DESCRIPTION OF DRAWINGS

FIG. 1 is a block diagram of a web conferencing system.

FIG. 2A is a hardware configuration diagram of a web conferencing terminal.

FIG. 2B is a hardware configuration diagram of a web conferencing terminal.

FIG. 3 is a functional block diagram of a web conferencing terminal according to the first embodiment.

FIG. 4 is a functional block diagram illustrating the details of a correlation operation section.

FIG. 5 is a diagram for explaining a first example of audio reduction processing to be carried out for the voice of a non-user who is present near a user, which is included in a distribution audio.

FIG. 6 illustrates a flowchart of a flow of processing to be carried out by a web conferencing system according to the first embodiment.

FIG. 7 is a diagram for explaining a second example of audio reduction processing to be carried out for a non-user voice.

FIG. 8 illustrates a flowchart of a flow of processing to be carried out by a web conferencing system, including second audio reduction processing for an uttered voice (voice uttered by a non-user which has been distributed on the system).

FIG. 9 illustrates a mesh network configuration among web conferencing terminals within the same location.

FIG. 10 is a diagram for explaining audio reduction processing for an uttered voice based on a distribution block list.

FIG. 11 illustrates a flowchart of a flow of processing to be carried out by a web conferencing system which supports third audio reduction processing for a non-user voice.

FIG. 12 is a configuration diagram of a web conferencing system according to the third embodiment.

FIG. 13 is a block diagram of a web conferencing terminal implemented by an information processing device.

FIG. 14 is a functional block diagram of a web conferencing terminal according to the third embodiment.

FIG. 15 illustrates a flowchart of a flow of processing to be carried out by a serverless web conferencing system.

### DESCRIPTION OF EMBODIMENTS

Hereinafter, exemplified embodiments of the present invention will be described with reference to the drawings. Throughout all the drawings, the same components are provided with the same reference signs, and repetitive explanation therefor will be omitted.

A chat system according to the present invention is a system configured to transmit and receive audio data among a plurality of chat terminals directly or via a chat server. The chat system is applicable, for example, a work support system for transmitting and receiving audio data among chat terminals worn by operators working at a work site, and between a chat terminal and a terminal at a management center located at a place distant from the work site.

Furthermore, the chat system according to the present invention is applicable to a voice chat system to be used in an e-sport played by a team with a plurality of members, which allows audio data to be transmitted and received among chat terminals worn by the team members, respectively, directly or via a chat server. The present invention is also applicable to an e-sport system or a game system in which a voice chat system is incorporated.

Hereinafter, the present invention will be described referring to, as an example, a web conferencing system in which the chat system according to the present invention is incorporated. The present invention can be expected to, for example, diversify and improve technology in labor-intensive industries, and thus contribute to Goal 8.2 (Achieve higher levels of economic productivity through diversification, technological upgrading and innovation, including through a focus on high-value added and labor-intensive sectors” of the Sustainable Development Goals (SDGs) proposed by the United Nations.

### First Embodiment of the Invention

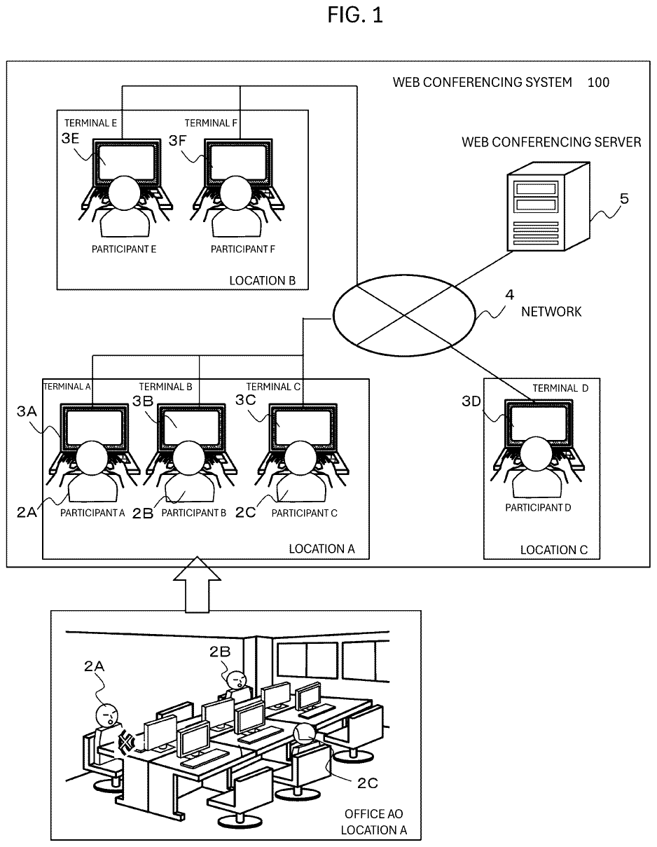

A first embodiment of the present invention will be described with reference to FIG. 1 to FIG. 8.

FIG. 1 is a block diagram of a web conferencing system.

In FIG. 1, a web conferencing system 100 is configured with web conferencing terminals 3A to 3F (corresponding to chat terminals, and hereinafter, may be simply referred to as “terminals”) installed in a location A, a location B, and a location C of a web conference, respectively, and a web conferencing server 5 (corresponding to a chat server), which are connected to each other via a network 4. An office AO is the room of the office set as the location A of the web conference.

In the following, the location A will be exemplified and described in detail, while the explanation made for the location A also is applicable to the locations B and C.

At the location A, participants 2A, 2B, 2C of the web conference are present. Web conferencing terminals used by the participants 2A, 2B, 2C are terminals 3A, 3B, 3C, respectively.

In this case, the participants 2A, 2B, 2C at the location A gathers in the same room, such as a conference room and use their own terminals 3A, 3B, 3C, respectively, to attend the web conference.

The participants 2A, 2B, 2C to attend the web conference at the location A use the terminals 3A, 3B, 3C, respectively, and access the web conferencing server 5 via the network 4 to use a web conferencing service. For example, the images of the participant A and his or her uttered voice (hereinafter, referred to as “user voice”) are collected by the terminal A and transmitted to the web conferencing server 5.

The web conferencing server 5 receives the images and voice of all the participants being connected to the web conferencing service, generates distribution images and distribution audio for the web conference, and distributes them to the terminals of the participants, respectively. For example, the voice uttered by the participant A (user voice) is delivered, as a part of the distribution audio for the web conference, to the terminals (terminal D, terminal E, and terminal F) of the participants at the location B and the location C.

However, the distribution audio output from the terminals of other participants who are near the participant A, which are, in the present example, the terminals 3B, 3C operated by the participants B, C, does not include the voice uttered by the participant A (user voice). With this feature, the inconvenience that the voice uttered by the participant A (non-user voice), which has been propagated through the air in the office AO and thus directly heard by the participants B, C, and the voice of the participant A (user voice) included in the distribution audio output from the terminals 3B, 3C are heard with a time difference can be solved. This is one of the features common to the embodiments of the present invention.

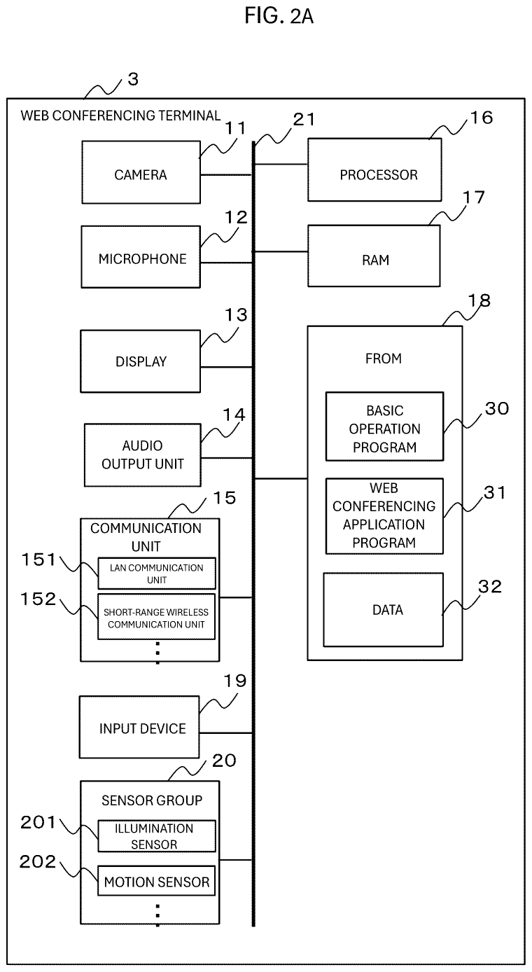

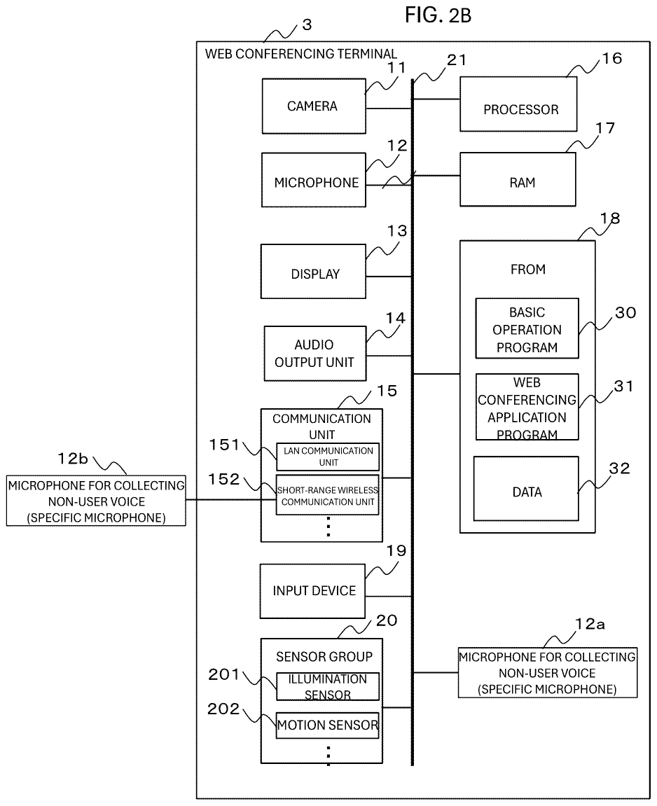

Each of FIG. 2A and FIG. 2B is a hardware configuration diagram of the web conferencing terminal. The configurations of the web conferencing terminals 3A to 3F are the same from each other, and thus in the following, the web conferencing terminals 3A to 3F will be referred to as terminal 3 if they do not have to be distinguished from each other.

The terminal 3 includes a camera 11, a microphone 12, a display 13, an audio output unit 14, a communication unit 15, a processor 16, a first storage device (RAM) 17, a second storage device (FROM) 18, an input device 19, and a sensor group 20, which are connected to each other via a bus 21. The terminal 3 does not necessarily have to include the camera 11 and the display 13, and in a configuration without them, a web conference using only audio is performed.

The processor 16 is configured with, for example, a CPU.

The RAM 17 is an example of a volatile memory.

The FROM 18 is an example of a non-volatile memory. The FROM 18 includes a basic operation program 30, a web conferencing application program 31, and data 32.

The camera 11 may be integrated with the terminal 3, or may be connected thereto using a USB terminal.

The microphone 12 collects, in addition to the voice of the user (user voice) of the terminal 3, the voice uttered by other participants (non-user voice) in the web conference at the same location. If one microphone 12 is provided and it is an omnidirectional microphone, the microphone 12 collects both the user voice and the non-user voice. The voice simply collected by the microphone 12 will be referred to as microphone collection audio herein, without distinguishing it between the user voice and the non-user voice.

FIG. 2A illustrates the case where one microphone 12 (user microphone) is provided and this single microphone 12 collects the user voice and the non-user voice, however, different microphones having different directivities suitable for collecting each voice may be provided. A microphone having directivity suitable for collecting the voice of the user of the terminal 3 is referred to as a user-specific microphone, and a microphone having directivity suitable for collecting the sound in the surroundings is referred to as a shared microphone. The user-specific microphone is, for example, a microphone included in the headset. The shared microphone is, for example, a microphone suitable for collecting the sound in all directions, which is to be placed on the desk of a conference room. As illustrated in FIG. 2B, a microphone for collecting non-user voice 12a (may be abbreviated as “specific microphone”) may be connected to the bus 21, or a microphone for collecting non-user voice 12b may be connected to Bluetooth (registered trademark) via a short-range wireless communication unit 152. The non-user voice is the voice collected by a microphone (user microphone or microphone for collecting non-user voice) while a speaker is not speaking. The configuration using the user microphone as a specific microphone is preferable as it does not require the additional microphone for collecting non-user voice 12b. The microphone 12 (user microphone) is set to be in a muted state (state where the function of the microphone 12 is active, but the voice collected by the microphone 12 is not to be delivered as the distribution audio) while the user is not speaking, so that the voice collected during that time is processed as the voice which is not the voice of the user, that is, which is the non-user voice.

The input device 19 is a keyboard or a touch sensor. In the case of a smartphone, a flat display (display 13) and a touch sensor are combined with each other, on which the keyboard works in accordance with the basic operation program 30.

The audio output device 14 is the device for outputting the distribution audio, and it may be a speaker, earphones, headphones, headsets, or an audio output terminal.

The communication unit 15 includes a plurality of communication systems of various types and communication protocols, for example, a LAN communication unit 151 for exchanging data such as images and audio with the web conferencing server 5, a short-range wireless communication unit 152, such as Bluetooth (registered trademark), used for communication among terminals within a location, and the like.

The sensor group 20 includes, for example, an illumination sensor 201, a motion sensor 202, and the like, which assists in use of the terminal.

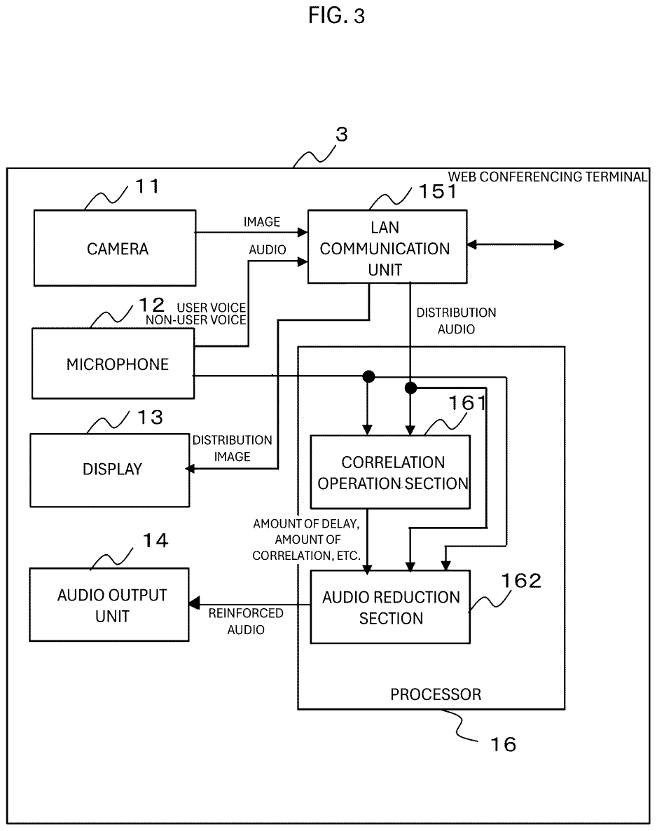

FIG. 3 is a functional block diagram of the web conferencing terminal according to the first embodiment.

The web conferencing terminal 3 includes a correlation operation section 161 and an audio reduction section 162. The processor 16 loads the basic operation program 30 and the web conferencing application program 31 in the RAM 17 and executes them to implement the functions of the correlation operation section 161 and those of the audio reduction section 162. The data 32 includes the data necessary for execution of the basic operation program 30 and the web conferencing application program 31, and is read as appropriate when the processor 16 executes the web conferencing application program 31 and is used for the processes carried out by each section.

The images of the user of the terminal captured by the camera 11 are transmitted from the LAN communication unit 151 to the web conferencing server 5 via the network 4.

The LAN communication unit 151 receives distribution images and distribution audio for the web conference from the web conferencing server 5. The distribution images are shown on the display 13. The distribution audio is supplied to the correlation operation section 161 and the audio reduction section 162.

Furthermore, the user voice and non-user voice collected by the microphone 12 (microphone collection voice) are transmitted from the LAN communication unit 151 to the web conferencing server 5 via the network 4, and also supplied to the correlation operation section 161 and the audio reduction section 162.

The correlation operation section 161 carries out a correlation operation using, as input, the distribution audio, and the user voice and the non-user voice from the microphone 12, so as to obtain the amount of delay, the amount of correlation, and the like therebetween, and transmits them to the audio reduction section 162.

The audio reduction section 162 generates the output audio for the terminal 3 by, for example, subtracting the user voice and the non-user voice from the distribution audio to reduce the user voice and the non-user voice from the distribution audio, referring to the amount of delay and the amount of correlation.

The audio output unit 14 outputs the output audio received from the audio reduction section 162. Thus, in output of the distribution audio from the audio output unit 14, the microphone collection audio (user voice and non-user voice) collected by the microphone 12 of the terminal is suppressed from being output as the distribution audio, and this enables reduction in the interference between the distribution audio and the non-user voice that is directly heard.

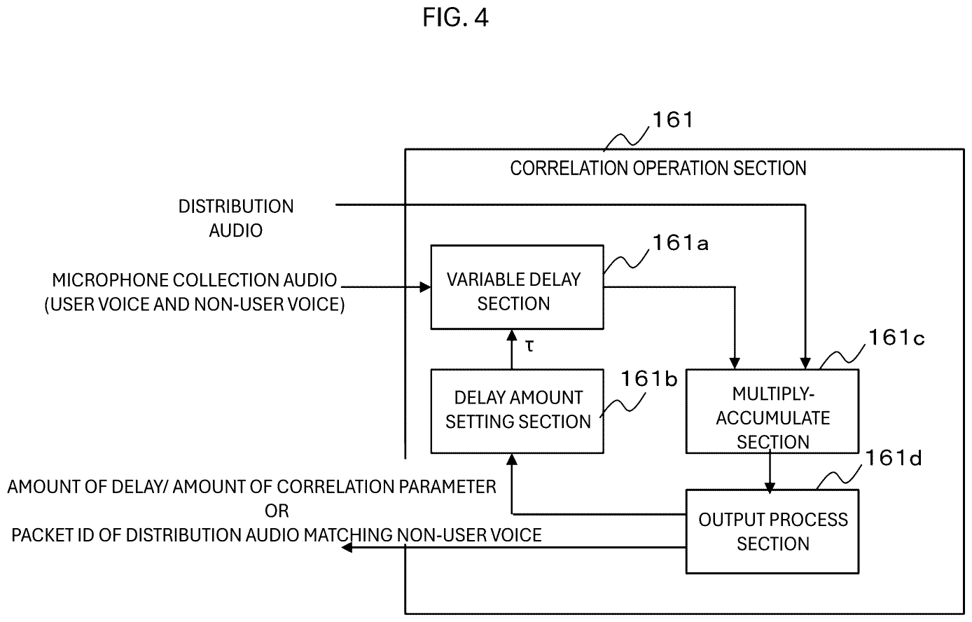

FIG. 4 is a functional block diagram illustrating the details of the correlation operation section.

The correlation operation section 161 includes a variable delay section 161a, a delay amount setting section 161b, a multiply-accumulate section 161c, and an output process section 161d.

The microphone collection audio (user voice and non-user voice) is input to the variable delay section 161a. The delay amount setting section 161b sets the delay time in the variable delay section 161a. The “uttered voice” to be input to the variable delay section 161a is the user voice, or the non-user voice collected in the muted state.

The multiply-accumulate section 161c receives the microphone collection audio (user voice and non-user voice) after being delay-processed and the distribution audio, carries out the multiply-accumulate operation to obtain the amount of correlation using, as a parameter, the delay time that has been set. The multiply-accumulate section 161c obtains the delay time at which the amount of correlation is maximized by varying the delay time, and sets the amount of delay and the amount of correlation in the distribution.

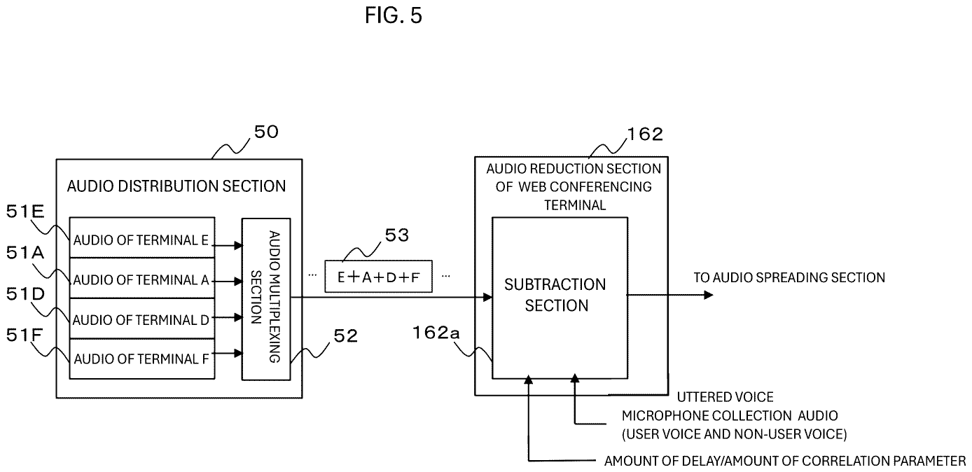

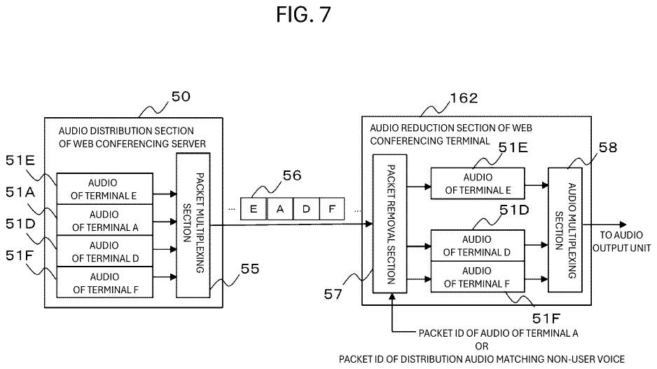

In the case where the distribution audio is the overlapping audio as illustrated in FIG. 5, which will be described later, the output process section 161d outputs the amount of delay and the correlation amount. In the case where the distribution audio is a packet multiplex audio as illustrated in FIG. 7, which will be described later, the output process section 161d compares the amount of correlation for each audio in a packet to be separated, and uses the packet ID corresponding to the microphone collection voice (user voice and non-user voice) as output.

### (First Example of Audio Reduction Processing)

FIG. 5 is a diagram for explaining a first example of the audio reduction processing to be carried out for the voice of a non-user who is present near the user, which is included in the distribution audio.

The web conferencing server 5 includes an audio distribution section 50. The audio distribution section 50 transmits distribution audio 53 to the audio reduction section 162.

An audio multiplexing section 52 overlaps and adds the voices collected by the terminals, which are, in FIG. 5, audio A of the terminal A and the audio collected by each of the other terminals 51E, 51D, 51F, and transmits the value thus obtained as the distribution audio 53.

A subtraction section 162a of the audio reduction section 162 refers to the amount of delay and the amount of correlation obtained by the correlation operation section 161, and subtracts the voice of the non-user (non-user voice) who is present near the user from the distribution audio 53.

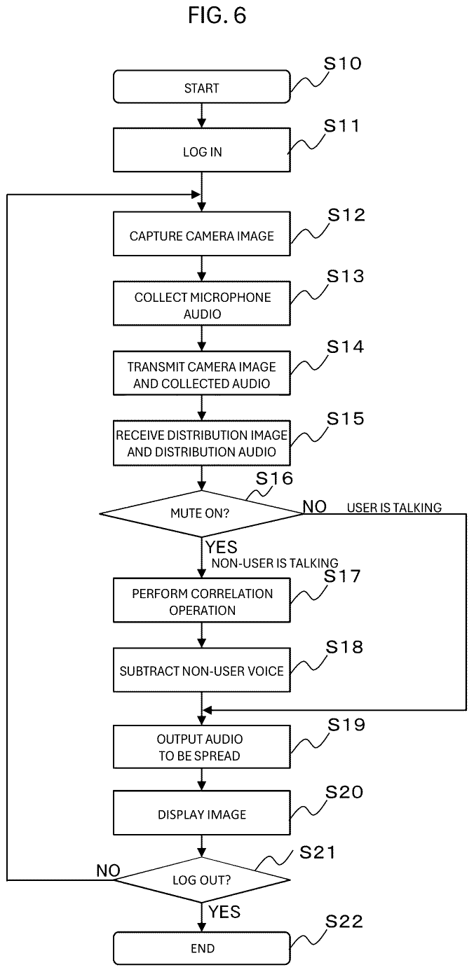

FIG. 6 illustrates a flowchart of a flow of the processing to be carried out by the web conferencing system according to the first embodiment.

Upon starting the web conferencing application program 31 (S10), the terminal 3 logs in the web conferencing service provided by the web conferencing server 5 (S11) to participate in the web conference.

The terminal 3 captures camera images using the camera 11 (S12), and also collects the voice using the microphone 12 (S13).

The terminal 3 transmits the camera images and the microphone collection audio collected by the microphone 12 of the terminal 3 to the web conferencing server 5 (S14). The web conferencing server 5 receives the distribution images and the distribution audio (S15).

In the case where a microphone mute button of the terminal 3 has been pressed and thus the terminal 3 is in a mute-ON state (S16: Yes), the user of the terminal 3 has no intention to speak, and accordingly, the terminal 3 determines that the voice collected by the microphone is the non-user voice.

Keeping the user microphone active even during its muted state as well enables it to be used as a microphone for collecting the non-user voice. Alternatively, a microphone for collecting the non-user voice may be provided separately from the user microphone. Placing the microphone for collecting the non-user voice near a person who is present close to the user of the terminal and participates and speaks in the conference enables the non-user voice to be collected more accurately, and thus the accuracy in the correlation operation to be improved. In the configuration using the microphone for collecting the non-user voice, step S13 for collecting a voice using a microphone is carried out using by the microphone for collecting the non-user voice. In this case, step S13 for collecting a voice using a microphone may be carried out when the terminal 3 is switched to the mute-ON state.

When the terminal 3 is in the mute-ON state (S16: Yes), the correlation operation section 161 performs the correlation operation for the distribution audio and the non-user voice, calculates the amount of delay and the amount of correlation, and outputs them to the audio reduction section 162.

Specifically, the audio reduction section 162 subtracts the voice collected by the microphone from the distribution audio (S17, S18), and the audio output unit 14 outputs the distribution audio from which the non-user voice has been subtracted (S18, S19). The audio output from the audio output unit 14 is referred to as an “audio to be spread”.

When the terminal 3 is in the mute-OFF state (S16: No), the distribution audio should not have included the user voice (voice of the user has been removed by a conventional method), and accordingly, the voice output unit 14 outputs the distribution audio as it is (S19).

In the case where the web conferencing application program is logged out (S21: NO), the processing returns to step S12 and is repeated. In the case where the web conferencing application program is logged out (S21: YES), the processing is ended (S22).

### (Second Example of Audio Reduction Processing)

FIG. 7 is a diagram for explaining a second example of the audio reduction processing to be carried out for the non-user voice.

In the same manner as FIG. 5, in FIG. 7, the audio distribution section 50 of the web conferencing server 5 is provided. The audio distribution section 50 transmits distribution audio 56 to the audio reduction section 162.

A packet multiplexing section 55 performs a packet multiplexing process for the audio of each of the terminals, which include the voice uttered in the web conference (audio 51A of the terminal A) and the voices collected by other terminals D, E, F (51D, 51E, 51F in FIG. 5). In the packet multiplexing process, the audio of each terminal is stored in a packet having a unique identification number (hereinafter, referred to as an ID), and the packet multiplexing section 55 delivers the data thus obtained as the distribution audio 56.

A packet removal section 57 of the audio reduction section 162 separates and removes the uttered voice (voice uttered by a non-user which has been distributed on the system) from the distribution audio 56, using the packet ID obtained by the correlation operation section 161. The terminal audio after the removal process includes 51D, 51E, and 51F, to which, thereafter, the multiplexing processing is performed by an audio multiplexing section 58, and then is transmitted to the audio output unit 14.

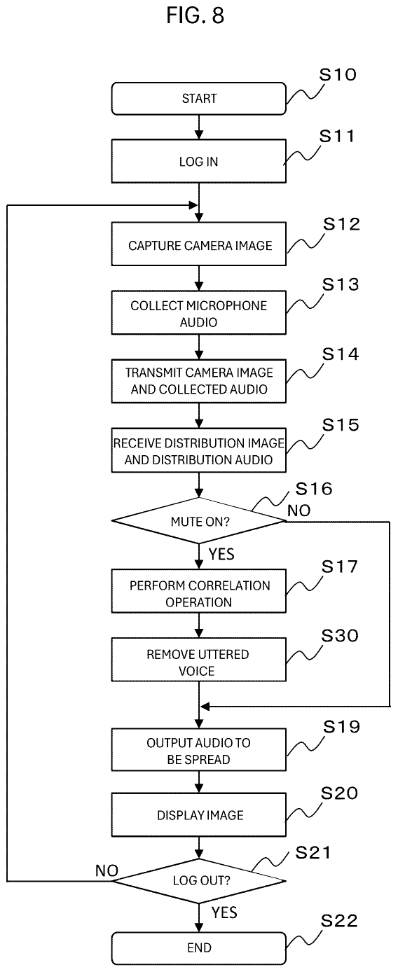

FIG. 8 illustrates a flowchart of a flow of the processing to be carried out by the web conferencing system, including the second audio reduction processing for an uttered voice (voice uttered by a non-user which has been distributed on the system).

The audio reduction processing is carried out in a similar manner to the audio reduction method illustrated in FIG. 7. The steps having the same functions as those in the first flowchart described with reference to FIG. 6 are provided with the same reference signs, and the repetitive explanation therefor will be omitted.

The flowchart illustrated in FIG. 8 differs from the flowchart illustrated in FIG. 6 in its step S30, in which an uttered voice (voice uttered by a non-user which has been distributed on the system) is removed by the packet removal method described with reference to FIG. 7.

As described above, according to the web conferencing terminal, the web conferencing application, and the web conferencing system of the first embodiment of the present invention, in a web conference with participants using their own web conferencing terminals, respectively, interference between an uttered voice of a participant and distribution audio of the web conference can be reduced, which makes it possible to hear the uttered voice easily.

### Second Embodiment of the Invention

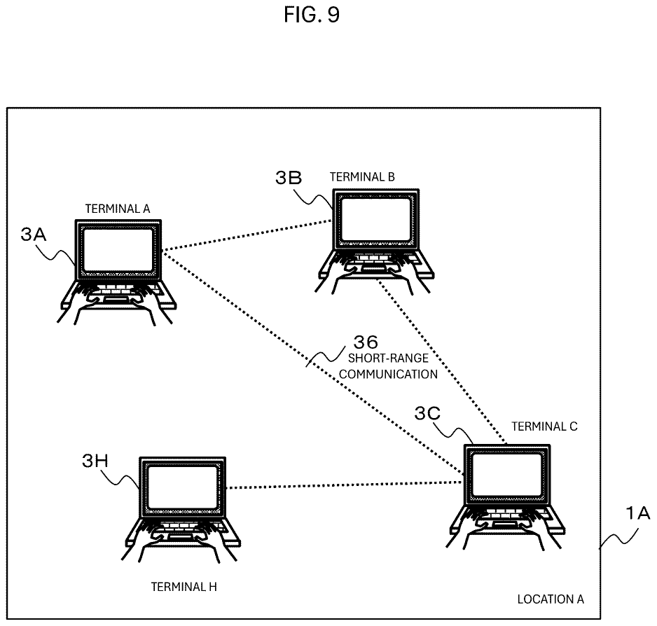

A second embodiment of the present invention will be described with reference to FIG. 9 to FIG. 11.

FIG. 9 illustrates a mesh network configuration among the web conferencing terminals within the same location. FIG. 9 illustrates a state in which the terminal A, the terminal B, and the terminal C are present at the location A and connected to each other via short-range communication 36, to which the terminal H is to be added.

Upon entering the location A, the terminal H searches for nearby devices via the short-range communication 36, and establishes the connection with the terminal C which is in a connectable condition. The terminal C detects a new participation of the terminal H and notifies the terminal A and the terminal B of it, and also transmits the information on the terminal A and that on the terminal B to the terminal H. This enables the terminal A, the terminal B, the terminal C, and the terminal H to obtain the information on all the terminals in the location A and thus create a block list for distribution audio to prevent the uttered voice collected by a different terminal within the same location from being included in the distribution audio.

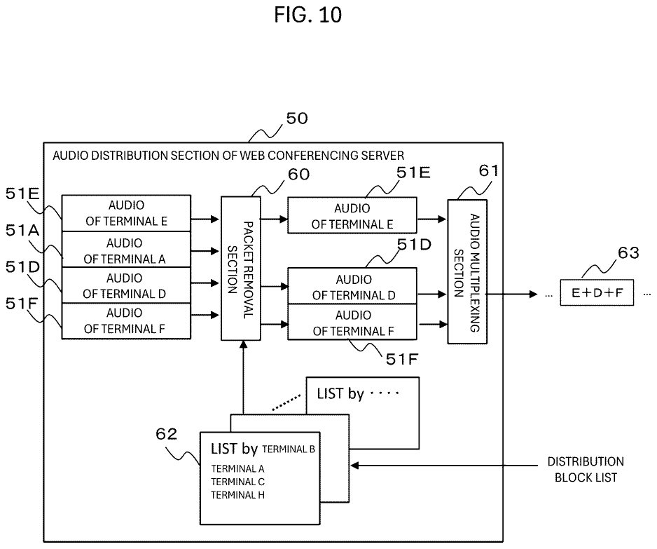

FIG. 10 is a diagram for explaining the audio reduction processing for an uttered voice based on a distribution block list, which illustrates the audio distribution section of the web conferencing server.

The microphone collection audio 51A collected by the microphone 12 of the terminal A and the microphone collection audio (51D, 51E, 51F) collected from each of other terminals are input to a packet removal section 60. An audio multiplexing section 61 adds the data values, and delivers the value thus obtained as distribution audio 63.

The audio distribution section 50 of the web conferencing server 5 receives a distribution block list 62 from a terminal of a participant, which is, for example, the distribution block list 62 of the terminal B listing the terminal A, the terminal C, and the terminal H that are present at the same location. As in the example described above, the distribution block list 62 specifies, for each terminal, a voice to be removed from the distribution audio for that terminal. A voice to be removed is defined by the name of a terminal (for example, terminals A, C, H) to which the microphone that has collected the voice is connected.

In generating the distribution audio for the terminal B, based on the distribution block list 62, the packet removal section 60 removes the packet of the audio listed in the distribution block list 62 for each terminal.

The audio multiplexing section 61 adds (multiplexes) the audio that is left after passing through the packet removal section 60, so as to generate the distribution audio 63 and deliver it to the terminal B.

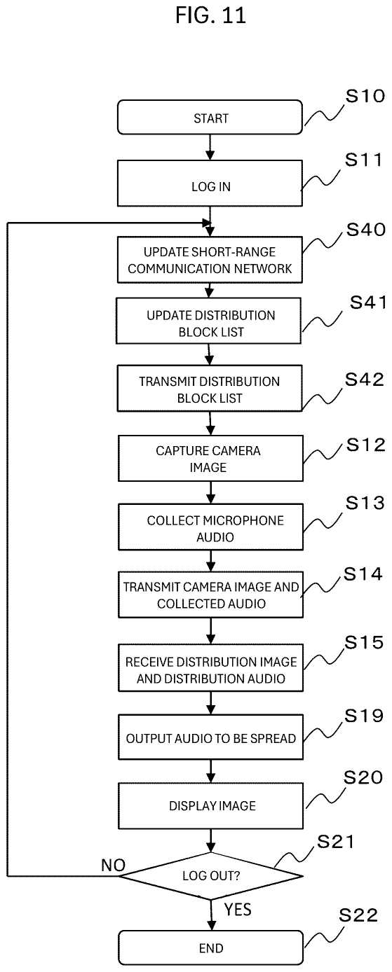

FIG. 11 illustrates a flowchart of a flow of the processing to be carried out by the web conferencing system which supports the third audio reduction processing for a non-user voice.

In the flowchart of FIG. 11, the steps having the same functions as those in the flowchart described with reference to FIG. 6 are provided with the same reference signs, and the repetitive explanation therefor will be omitted.

The flowchart illustrated in FIG. 11 differs from the first flowchart illustrated in FIG. 6 in its steps S40, S41, S42, and in S40, a short-range communication network described with reference to FIG. 9 is newly created or updated. In S41, the distribution block list 62 is newly created or updated, and in S42, the distribution block list 62 is transmitted to the web conferencing server 5.

In S15, the web conferencing server 5 transmits the distribution images and the distribution audio, however, as described with reference to FIG. 10, the distribution audio does not include the non-user voice uttered by a different participant who is present in the same location.

As described above, the web conferencing terminal, the web conferencing application, and the web conferencing system according to the second embodiment of the present invention include the same features as those of the first embodiment, and further enables reliable reduction of the non-user voice uttered by a different participant who is present in the same location.

### Third Embodiment of the Invention

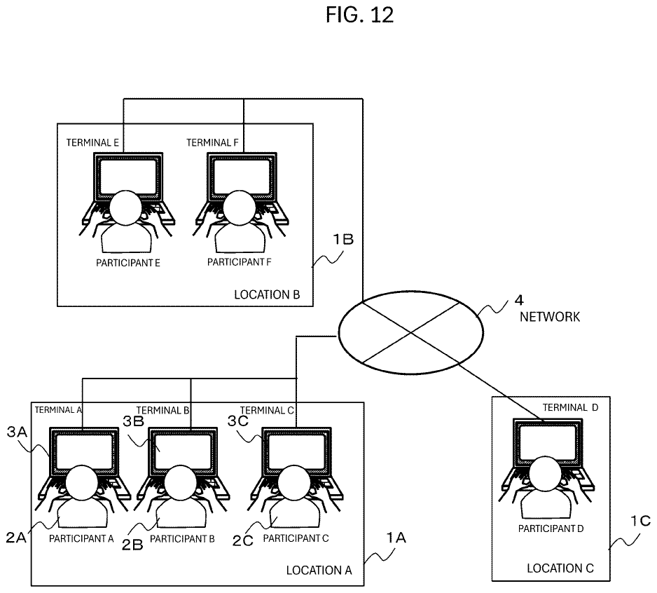

A third embodiment of the present invention will be described with reference to FIG. 12 to FIG. 14. The present embodiment relates to an example of a web conference which can be performed even without using the web conferencing server 5.

FIG. 12 is a configuration diagram of a web conferencing system according to the third embodiment.

The web conferencing system illustrated in FIG. 12 differs from the web conferencing system illustrated in FIG. 1 in that it is a serverless system without including the web conferencing server 5. For example, the camera images and the microphone collection audio of the participant 2A, which have been captured and collected by the terminal 3A, are distributed to the terminals (terminals B to F) of all the participants attending the web conference.

The terminal 3A receives the images and audio from all the terminals (terminals B to F), and generates the images and audio for the web conference within the terminal.

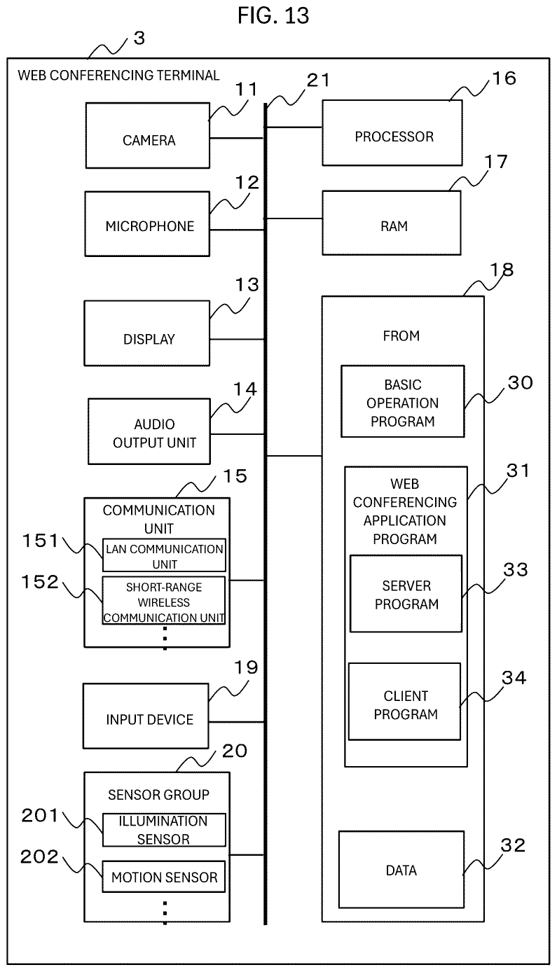

FIG. 13 is a block diagram of a web conferencing terminal implemented by an information processing device, which is a web conferencing terminal for a serverless web conference. For the web conferencing terminal illustrated in FIG. 13, the blocks having the same functions as those of the web conferencing terminal illustrated in FIG. 3 are provided with the same reference numbers, and the repetitive explanation therefor will be omitted.

In the terminal 3 illustrated in FIG. 13, the web conferencing application program 31 included in the FROM 18 includes a server program 33 and a client program 34. The server program 33 distributes the camera image and the microphone collection audio of the terminal user to other terminals, and receives the images and the audio from the other terminals.

The client program 34 captures and collects the camera images and the microphone collection audio of the terminal user, and shares, with the server program 33, the camera image and the microphone collection audio of the terminal user, and the camera images and the microphone collection audio from the other terminals.

The server program 33 generates the images and audio for the web conference, and outputs them to the display 13 and the audio output unit 14 via the client program 34. The server programs 33 do not necessarily have to be implemented in all the terminals participating in the web conference, and the web conference can be performed as long as the program is implemented in at least one terminal. In that case, transmission and reception of the images and audio between the terminal in which the server program 33 is implemented and the client program 34 of the other terminal is carried out via a communication section 24.

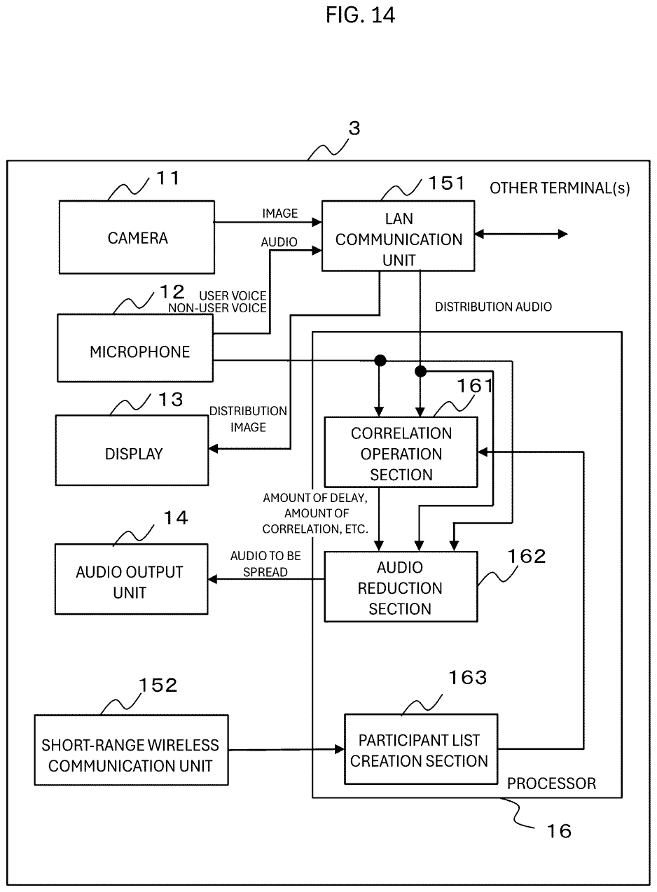

FIG. 14 is a functional block diagram of a web conferencing terminal according to the third embodiment.

In addition to the configuration of the terminal 3 illustrated in FIG. 2, the terminal 3 illustrated in FIG. 14 further includes a participant list creation section 163 configured to create a participant list based on the result of communication using short-range communication 35, which has been acquired from the short-range wireless communication unit 152.

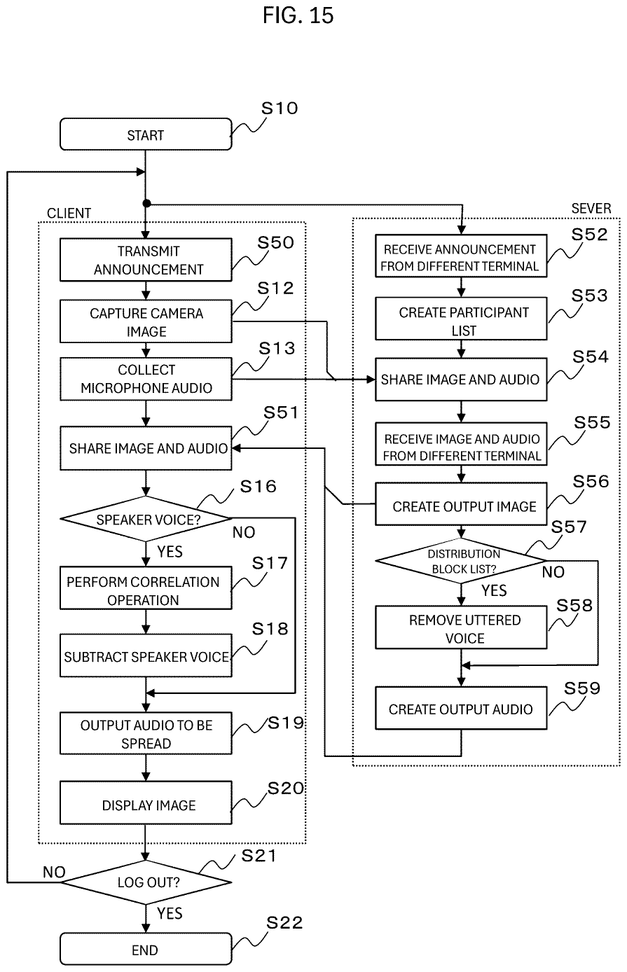

FIG. 15 illustrates a flowchart of a flow of the processing to be carried out by the serverless web conferencing system.

In FIG. 15, the steps which are the same as those in the flowchart of the processing to be carried out by the web conferencing system illustrated in FIG. 6 are provided with the same reference signs.

The program is started (S10). The flowchart of a flow of the processing to be carried out by the web conferencing system includes a client process and a server process.

In the client process, an announcement that the terminal has been participated in the web conference is issued (S50). The announcement is issued to the terminals of the participation candidates listed in a participation candidate list that has been acquired in advance.

The camera images are captured (S12) and the voice is collected by the microphone 12 (S13), and then the camera images and the audio are shared with the server process.

Furthermore, in S51, the images and the audio output by the server process are shared.

In S16, it is checked whether a non-user voice uttered by a different participant at the same location is included in the microphone collection audio shared in S51. When it is determined that the non-user voice is included (S16: YES), the correlation operation section 161 performs a correlation operation for the output audio acquired from the server process and the non-user voice uttered by the different participant at the same location (S17), outputs a parameter indicative of the amount of delay and the amount of correlation to the audio reduction section 162. The audio reduction section 162 subtracts the non-user voice uttered by the participant (S18), and outputs the audio to be spread (S19). Furthermore, the images shared in step S51 are shown on the display 13 (S20).

In the server process, upon reception of an announcement issued from each of the terminals (S52), the participant list creation section 163 newly creates or updates a participant list of participants who are actually participating in the conference based on a participation candidate list that has been distributed in advance (S53).

In S54, the camera images and the collection audio are shared with the client process, and further the camera images and audio are acquired from other terminals in S55. In S56, the images to be output for the web conference are obtained based on the camera images of all the terminals.

In S57, it is checked whether there is a distribution block list and, if any, whether the uttered voice is included in the distribution block list. When a distribution block list has found and the uttered voice is included in the distribution block list (S57: YES), the non-user voice is to be removed (S58). The distribution block list configured within the participant list in such a manner that the participant list includes a distribution block item (flag). In that case, a distribution block participant list in the participant list corresponds to the distribution block list.

If no distribution block list has found or the distribution block list does not include the non-user voice (S57: NO), step S58 is skipped. Then, in step S59, the audio to be output is generated and shared with the client process.

The images and audio output by the server process correspond to the distribution images and the distribution audio of the web conferencing system including a server.

As described above, the web conferencing terminal, the web conferencing application, and the web conferencing system according to the third embodiment of the present invention include the same features as those of the first and second embodiments, and further enables a serverless web conference. The serverless web conference is advantageous in terms of cost in the case where the web conference is performed with a small number of terminals.

### Fourth Embodiment of the Invention

For the case where a web conference participant attends a web conference using noise canceling headphones (hereinafter, referred to as NCH), it may be configured that the voice of a speaker included in the system audio output from the NCH is not reduced while the actual voice (of the speaker) uttered on the spot is reduced by the noise canceling technique. However, in that case, the external sounds other than the voice uttered by the speaker are also reduced, which causes inconvenience that, during the web conference, the user cannot be aware of a calling sound of a telephone or the voice of someone calling the user. For this problem, it may be configured to enable the noise canceling function of the NCH only while the speaker is actually speaking so as to reduce the voice actually uttered by the speaker, and disable the noise canceling function while the speaker is not actually speaking so as not to reduce the external sounds. This enables the user to be aware of the external sounds other than the non-user voice. Furthermore, with the configuration of performing noise cancellation of the external sounds only for the uttered voice of the system sound, only the uttered voice can be reduced, and also, the other external sounds can be aware even while the uttered voice is present.

Although the web conferences have been exemplified in the embodiments described above, the techniques according to the present invention are effective not only in the web conferences but also in a system using an information terminal, which enables a conversation among remote locations involving a participant being near the information terminal.

In the above, the embodiments of the present invention have been described. Needless to say, the present invention is not limited to the embodiments described above, and various modifications can be made for the present invention. For example, the embodiments described above have been explained in detail for the purpose of making it to understand the present invention easily, and thus are not necessarily limited to those having all the configurations as described. Furthermore, a part of the configuration of an embodiment may be replaced with the configuration of a further embodiment, and the configuration of an embodiment may include the configuration of a further embodiment, which are all included in the scope of the present invention. The numerical values and messages appearing in the text and drawings are merely examples, and accordingly, the advantageous effects of the present invention are not impaired even if different ones are used.

Furthermore, each of the programs described in the examples of the processing may be an independent program, or a plurality of programs configuring one application program. Still further, the orders of executing the processes may be changed.

Still further, some or all the functions and the like of the present invention may be implemented by hardware, for example, by designing them with integrated circuitry. Still further, a microprocessor unit, a CPU, or the like may interpret and execute an operation program so that some or all the functions and the like of the present invention can be implemented by software. Still further, the implementation range of the software is not limited, and hardware and software may be used in combination. Still further, some or all the functions may be implemented by a server. Note that the server may be the one which executes the functions in cooperation with other components by communication, which may be, for example, a local server, a cloud server, an edge server, a net service, or the like. Information such as programs, tables, and files for realizing the functions may be stored in a recording device such as a memory, a hard disk, or an SSD (Solid State Drive), or a recording medium such as an IC card, an SD card, or a DVD, or may be stored in a device on a communication network.

Still further, the control lines and information lines which are considered to be necessary for the purpose of explanation are indicated herein, but not all the control lines and information lines of actual products are necessarily indicated. It may be considered that almost all the components are actually connected to each other.

The embodiments described above include the following aspects.

### Appendix 1

A chat terminal comprising:
a microphone;
a communication unit for transmitting and receiving data to and from a chat server;
an audio output unit; and
a processor,
the microphone being configured to collect a user voice uttered by a terminal user and a non-user voice uttered by a non-user who is present near the terminal user,
the communication unit being configured to transmit the user voice to the chat server and receive a distribution audio from the chat server, and
the processor being configured to:
   obtain a correlation between the distribution audio and the non-user voice;
   reduce the non-user voice included in the distribution audio; and
   output the distribution audio from which the non-user voice has been reduced to the audio output unit.

### Appendix 2

A chat terminal comprising:
a microphone;
a communication unit for transmitting and receiving data to and from another chat terminal;
an audio output unit; and
a processor,
the microphone being configured to collect a user voice uttered by a terminal user and a non-user voice uttered by a non-user who is present near the terminal user,
the communication unit being configured to transmit the user voice to an external device the other chat terminal and receive a distribution audio from the other chat terminal, and
the processor being configured to:
   obtain a correlation between the distribution audio and the non-user voice;
   reduce the non-user voice included in the distribution audio; and
   output the distribution audio from which the non-user voice has been reduced to the audio output unit.

### Appendix 3

A chat system configured with a chat terminal and a chat server, the chat terminal and the chat server being connected so as to communicate from each other,
the chat terminal including:
   a microphone;
   a communication unit for transmitting and receiving data to and from a chat server;
   an audio output unit; and
   a processor,
the microphone being configured to collect a user voice uttered by a terminal user and a non-user voice uttered by a non-user who is present near the terminal user,
the communication unit being configured to transmit the user voice to the chat server and receive a distribution audio from the chat server, and
the processor being configured to:
   obtain a correlation between the distribution audio and the non-user voice;
   reduce the non-user voice included in the distribution audio; and
   output the distribution audio from which the non-user voice has been reduced to the audio output unit.

### Appendix 4

A method of controlling a chat system configured with a chat terminal and a chat server, the chat terminal and the chat server being connected so as to communicate from each other, the method comprising:
collecting, using a microphone connected to the chat terminal, a user voice uttered by a terminal user and a non-user voice uttered by a non-user who is present near the terminal user;
transmitting the user voice to the chat server and receiving a distribution audio from the chat server;
obtaining a correlation between the distribution audio and the non-user voice;
reducing the non-user voice included in the distribution audio; and
outputting the distribution audio from which the non-user voice has been reduced to an audio output unit connected to the chat terminal.

### REFERENCE SIGNS LIST

2A: participant
2B: participant
2C: participant
3: web conferencing terminal
3A: web conferencing terminal
3B: web conferencing terminal
3C: web conferencing terminal
3D: web conferencing terminal
3E: web conferencing terminal
3F: web conferencing terminal
4: network
5: web conferencing server
11: camera
12: microphone
12a: microphone for collecting non-user voice
12b: microphone for collecting non-user voice
13: display
14: audio output unit
15: communication unit
16: processor
17: RAM
19: input device
20: sensor group
21: bus
24: communication section
30: basic operation program
31: web conferencing application program
32: data
33: server program
34: client program
35: short-range communication
36: short-range communication
50: audio distribution section
51A: microphone collection audio
52: audio multiplexing section
53: distribution audio
55: packet multiplexing section
56: distribution audio
57: packet removal section
58: audio multiplexing section
60: packet removal section
61: audio multiplexing section
62: distribution block list
63: distribution audio
100: web conferencing system
151: LAN communication unit
152: short-range wireless communication unit
161: correlation operation section
161a: variable delay section
161b: delay amount setting section
161c: multiply-accumulate section
161d: output process section
162: audio reduction section
162a: subtraction section
163: participant list creation section
201: illumination sensor
202: motion sensor

1. A chat terminal comprising:
a microphone;
a communication unit for transmitting and receiving data to and from a chat server;
an audio output unit; and
a processor,
the microphone being configured to collect a user voice uttered by a terminal user and a non-user voice uttered by a non-user who is present near the terminal user,
the communication unit being configured to transmit the user voice to the chat server and receive a distribution audio from the chat server, and
the processor being configured to:
obtain a correlation between the distribution audio and the non-user voice;
reduce the non-user voice included in the distribution audio; and
output the distribution audio from which the non-user voice has been reduced to the audio output unit.

2. The chat terminal according to claim 1, further comprising:
a camera; and
a display, wherein
the communication unit further transmits an image captured using the camera to the chat server, and further receives a distribution image from the chat server, and
the processor shows the distribution image on the display.

3. The chat terminal according to claim 1, further comprising a short-range wireless communication unit, wherein
the short-range wireless communication unit recognizes presence of a nearby terminal, and
the processor creates a distribution block list based on a result of communication performed by the short-range wireless communication unit, and output, through the audio output unit, an audio from which a non-user voice listed in the distribution block list has been removed.

4. A chat terminal comprising:
a microphone;
a communication unit for transmitting and receiving data to and from another chat terminal;
an audio output unit; and
a processor,
the microphone being configured to collect a user voice uttered by a terminal user and a non-user voice uttered by a non-user who is present near the terminal user,
the communication unit being configured to transmit the user voice to the other chat terminal and receive a distribution audio from the other chat terminal, and
the processor being configured to:
obtain a correlation between the distribution audio and the non-user voice;
reduce the non-user voice included in the distribution audio; and
output the distribution audio from which the non-user voice has been reduced to the audio output unit.

5. A chat system configured with a chat terminal and a chat server, the chat terminal and the chat server being connected so as to communicate from each other,
the chat terminal including:
a microphone;
a communication unit for transmitting and receiving data to and from a chat server;
an audio output unit; and
a processor,
the microphone being configured to collect a user voice uttered by a terminal user and a non-user voice uttered by a non-user who is present near the terminal user,
the communication unit being configured to transmit the user voice to the chat server and receive a distribution audio from the chat server, and
the processor being configured to:
obtain a correlation between the distribution audio and the non-user voice;
reduce the non-user voice included in the distribution audio; and
output the distribution audio from which the non-user voice has been reduced to the audio output unit.

6. A method of controlling a chat system configured with a chat terminal and a chat server, the chat terminal and the chat server being connected so as to communicate from each other, the method comprising:
collecting, using a microphone connected to the chat terminal, a user voice uttered by a terminal user and a non-user voice uttered by a non-user who is present near the terminal user;
transmitting the user voice to the chat server and receiving a distribution audio from the chat server;
obtaining a correlation between the distribution audio and the non-user voice;
reducing the non-user voice included in the distribution audio; and
outputting the distribution audio from which the non-user voice has been reduced to an audio output unit connected to the chat terminal.
